(19) United States
(12) Patent Application Publication
(10) Pub. No.: US 2026/0038061 A1
(43) Pub. Date: Feb. 5, 2026

(54) SYSTEMS AND METHODS FOR COMPUTING THE IMPACT OF POLICIES ON POST-DISASTER CONSTRUCTION COST VARIATIONS

(71) Applicant: Board of Regents, The University of Texas System, Austin, TX (US)

(72) Inventors: Mohsen SHAHANDASHTI, Arlington, TX (US); Sooin KIM, Detroit, MI (US)

(73) Assignee: Board of Regents, The University of Texas System, Austin, TX (US)

(21) Appl. No.: 19/286,601

(22) Filed: Jul. 31, 2025

Related U.S. Application Data
(60) Provisional application No. 63/677,791, filed on Jul. 31, 2024.

(51) Int. Cl. G06Q 50/08; G06Q 10/0631

(52) U.S. Cl. CPC G06Q 50/08; G06Q 10/06313

(57) ABSTRACT

Systems and methods for model selection and use are described. An example system includes one or more processors, and a non-transitory memory in communication with the one or more processors, and storing instructions thereon. The instructions, when executed by the one or more processors, are configured to cause the system to receive a selection of a disaster-related policy for analysis; collect data associated with the disaster-related policy. The system is further caused to specify an estimator for computing an impact of the selected disaster-related policy and, using the collected data, select a panel data model of a plurality of panel data models to implement the estimator. The system is further caused to develop a geospatial Geographic Information System (GIS) database comprising the collected data. The system is further caused to, using the selected panel data model and the GIS database, compute the impact of the selected disaster-related policy.

### CROSS-REFERENCE TO RELATED APPLICATIONS

This application claims priority to U.S. Provisional App. No. 63/677,791, filed Jul. 31, 2024, and titled “SYSTEMS AND METHODS FOR COMPUTING THE IMPACT OF POLICIES ON POST-DISASTER CONSTRUCTION COST VARIATIONS.”

### STATEMENT REGARDING FEDERALLY SPONSORED RESEARCH

This invention was made with government support under Grant No. HDBE2155201 awarded by the National Science Foundation. The Government has certain rights in the invention.

### FIELD

The present application relates to systems and methods for model selection from a set of models, and more particularly to selecting a model for accurately computing the impact of policies on post-disaster construction cost variation using a panel data model implementing a difference in differences (DiD) estimator.

### BACKGROUND

In various contexts, models may be utilized for estimating and/or otherwise predicting effects on data. The accuracy of different models may be different, such that selection of a certain model over another model may result in a difference in accuracy of predictions generated by the selected model. The inventors have identified that it is desirable to select a model that enhances accuracy.

### SUMMARY

In one aspect, an example system for selecting a model for accurately determining the impact of a disaster-related policy on post-disaster construction cost is described herein. In another aspect, an example method for selecting a model for accurately determining the impact of a disaster-related policy on post-disaster construction cost is described herein. At a high level, the disclosed example systems and methods relate to selecting a model that accurately performs measuring differences in post-disaster construction cost variations with a selected policy and without the selected policy.

In some embodiments, the system can include one or more processors and a non-transitory memory in communication with the one or more processors and storing instructions thereon, that when executed by the processors are configured to cause the system to perform a method of selecting a model for accurately computing the impact of policies on post-disaster construction cost variations. In one example, the system receives a selection of a disaster-related policy for analysis. The system further collects data associated with the disaster-related policy. The data in some examples includes construction material costs over time, construction labor costs over time, construction equipment costs over time, the date or period of a disaster occurrence for the selected area, disaster-related policy information (e.g., which policies were active and during which time periods). The panel data can include one or more confounding variables that may be tracked and accounted for. In some embodiments, the one or more confounding variables that are collected as part of the panel data can include one or more of construction market variables (e.g., number of housing starts, construction spending), macroeconomic variables (e.g., GDP, inflation rates), demographic variables (e.g., ages, race, gender), and socioeconomic variables (e.g., poverty rates, income, education). The example system further specifies an estimator for computing an impact of the selected disaster-related policy. The example system further, using the collected data, selects a panel data model of a plurality of panel data models to implement the estimator. The example system further develops a geospatial Geographic Information System (GIS) database including the collected data. The example system further, using the selected panel data model and the GIS database, computes the impact of the selected disaster-related policy.

In some embodiments of the system, the data associated with the disaster-related policy includes one or more of construction material costs, construction labor costs, construction equipment costs, date or period of disaster occurrences, disaster-related policy information, and one or more confounding variables.

In some embodiments of the system, the one or more confounding variables include one or more of construction market variables, macroeconomic variables, demographic variables, and socioeconomic variables.

In some embodiments of the system, the estimator includes a difference-in-difference (DiD) estimator.

In some embodiments of the system, to select the panel data model the system is caused to perform a first diagnostic test to determine whether one or more time-invariant region-specific effects are present; and in response to the one or more time-invariant region-specific effects being present, perform a second diagnostic test to determine whether the one or more time-invariant region-specific effects are correlated with at least one independent variable of the selected panel data model.

In some embodiments of the system, the first diagnostic test includes the Breusch-Pagan test and the second diagnostic test includes the Hausman test.

In some embodiments of the system, the selected panel data model includes a pooled regression model when the one or more time-invariant region-specific effects are not present; the selected panel data model includes a random-effects model when at least one of the one or more time-invariant region-specific effects are not correlated with at least one independent variable of the selected panel data model; and the selected panel data model includes a fixed-effects model when at least one of the one or more time-invariant region-specific effects are correlated with at least one independent variable of the selected panel data model.

In some embodiments of the system, additional instructions further cause the system to conduct one or more panel unit root tests to determine the stationarity of the collected data. Responsive to determining the collected data is non-stationary: conduct one or more panel co-integration tests to determine whether a long-run relationship exists between variables of the collected data; and implement a natural logarithm transformation on the collected data prior to specifying the estimator to correct for heteroskedasticity and non-stationarity.

In accordance with another aspect of the disclosure, a method of selecting a model for accurately computing the impact of policies on post-disaster construction cost variations is provided. In one example, the method includes receiving a selection of a disaster-related policy for analysis. The method further includes collecting data associated with the disaster-related policy. The data in some examples includes construction material costs over time, construction labor costs over time, construction equipment costs over time, the date or period of a disaster occurrence for the selected area, disaster-related policy information (e.g., which policies were active and during which time periods). The panel data can include one or more confounding variables that may be tracked and accounted for. In some embodiments, the one or more confounding variables that are collected as part of the panel data can include one or more of construction market variables (e.g., number of housing starts, construction spending), macroeconomic variables (e.g., GDP, inflation rates), demographic variables (e.g., ages, race, gender), and socioeconomic variables (e.g., poverty rates, income, education). The example method further includes specifying an estimator for computing an impact of the selected disaster-related policy. The example method further includes, using the collected data, selecting a panel data model of a plurality of panel data models to implement the estimator. The example method further includes developing a geospatial Geographic Information System (GIS) database including the collected data. The example method further includes, using the selected panel data model and the GIS database, computing the impact of the selected disaster-related policy.

In some embodiments of the method, the data associated with the disaster-related policy includes one or more of construction material costs, construction labor costs, construction equipment costs, date or period of disaster occurrences, disaster-related policy information, and one or more confounding variables.

In some embodiments of the method, the one or more confounding variables include one or more of construction market variables, macroeconomic variables, demographic variables, and socioeconomic variables.

In some embodiments of the method, the estimator includes a difference-in-difference (DiD) estimator.

In some embodiments of the method, selecting the panel data model includes performing a first diagnostic test to determine whether one or more time-invariant region-specific effects are present; and in response to the one or more time-invariant region-specific effects being present, performing a second diagnostic test to determine whether the one or more time-invariant region-specific effects are correlated with at least one independent variable of the selected panel data model.

In some embodiments of the method, the first diagnostic test includes the Breusch-Pagan test and the second diagnostic test includes the Hausman test.

In some embodiments of the method, the selected panel data model includes a pooled regression model when the one or more time-invariant region-specific effects are not present; the selected panel data model includes a random-effects model when at least one of the one or more time-invariant region-specific effects are not correlated with at least one independent variable of the selected panel data model; and the selected panel data model includes a fixed-effects model when at least one of the one or more time-invariant region-specific effects are correlated with at least one independent variable of the selected panel data model.

In some embodiments of the method, the method further includes conducting one or more panel unit root tests to determine the stationarity of the collected data. The method further includes, responsive to determining the collected data is non-stationary: conducting one or more panel co-integration tests to determine whether a long-run relationship exists between variables of the collected data; and implementing a natural logarithm transformation on the collected data prior to specifying the estimator to correct for heteroskedasticity and non-stationarity.

In accordance with another aspect of the disclosure, a non-transitory computer-readable storage medium for accurately computing the impact of policies on post-disaster construction cost variations is provided. In one example, the non-transitory computer-readable storage medium has computer instructions stored thereon that, when executed by at least one processor, are configured for collecting data associated with the disaster-related policy. The data in some examples includes construction material costs over time, construction labor costs over time, construction equipment costs over time, the date or period of a disaster occurrence for the selected area, disaster-related policy information (e.g., which policies were active and during which time periods). The panel data can include one or more confounding variables that may be tracked and accounted for. In some embodiments, the one or more confounding variables that are collected as part of the panel data can include one or more of construction market variables (e.g., number of housing starts, construction spending), macroeconomic variables (e.g., GDP, inflation rates), demographic variables (e.g., ages, race, gender), and socioeconomic variables (e.g., poverty rates, income, education). The example non-transitory computer-readable storage medium further is configured for specifying an estimator for computing an impact of the selected disaster-related policy. The example non-transitory computer-readable storage medium further is configured for, using the collected data, selecting a panel data model of a plurality of panel data models to implement the estimator. The example non-transitory computer-readable storage medium further is configured for developing a geospatial Geographic Information System (GIS) database including the collected data. The example non-transitory computer-readable storage medium further is configured for, using the selected panel data model and the GIS database, computing the impact of the selected disaster-related policy.

In some embodiments of the non-transitory computer-readable storage medium, the data associated with the disaster-related policy includes one or more of construction material costs, construction labor costs, construction equipment costs, date or period of disaster occurrences, disaster-related policy information, and one or more confounding variables.

In some embodiments of the non-transitory computer-readable storage medium, the one or more confounding variables include one or more of construction market variables, macroeconomic variables, demographic variables, and socioeconomic variables.

In some embodiments of the non-transitory computer-readable storage medium, the estimator includes a difference-in-difference (DiD) estimator.

In some embodiments of the non-transitory computer-readable storage medium, selecting the panel data model includes performing a first diagnostic test to determine whether one or more time-invariant region-specific effects are present; and in response to the one or more time-invariant region-specific effects being present, performing a second diagnostic test to determine whether the one or more time-invariant region-specific effects are correlated with at least one independent variable of the selected panel data model.

In some embodiments of the non-transitory computer-readable storage medium, the first diagnostic test includes the Breusch-Pagan test and the second diagnostic test includes the Hausman test.

In some embodiments of the non-transitory computer-readable storage medium, the selected panel data model includes a pooled regression model when the one or more time-invariant region-specific effects are not present; the selected panel data model includes a random-effects model when at least one of the one or more time-invariant region-specific effects are not correlated with at least one independent variable of the selected panel data model; and the selected panel data model includes a fixed-effects model when at least one of the one or more time-invariant region-specific effects are correlated with at least one independent variable of the selected panel data model.

In some embodiments of the non-transitory computer-readable storage medium, the method further includes conducting one or more panel unit root tests to determine the stationarity of the collected data. The method further includes, responsive to determining the collected data is non-stationary: conducting one or more panel co-integration tests to determine whether a long-run relationship exists between variables of the collected data; and implementing a natural logarithm transformation on the collected data prior to specifying the estimator to correct for heteroskedasticity and non-stationarity.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 illustrates an example system in accordance with at least some example embodiments of the present disclosure;

FIG. 2 illustrates a system architecture diagram of an example apparatus in accordance with at least some example embodiments of the present disclosure;

FIG. 3 illustrates estimation of a policy impact on post-disaster construction cost variation in accordance with at least some example embodiments of the present disclosure;

FIG. 4 illustrates an example development of an example geospatial GIS database in accordance with at least some example embodiments of the present disclosure;

FIG. 5 illustrates a diagram of an example system that computes the impact of a policy on post-disaster construction cost variations in accordance with at least some example embodiments of the present disclosure;

FIG. 6 illustrates a flowchart of an example method/process for computing a policy's impact on post-disaster construction cost variations in accordance with at least some example embodiments of the present disclosure;

FIG. 7 illustrates an example DiD framework in accordance with at least some example embodiments of the present disclosure;

FIG. 8 illustrates an example framework of a DiD parametric model selection process in accordance with at least some example embodiments of the present disclosure; and

FIG. 9 illustrates a flowchart of an example method/process for selecting a model for accurately determining the impact of a disaster-related policy in accordance with at least some example embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. Example Use Case

Embodiments described herein can be understood more readily by reference to the following detailed description and examples below. The example systems and methods described below, however, are not limited to the specific embodiments presented in the detailed description and examples. It should be recognized that these embodiments are merely illustrative of the principles of the present disclosure. Numerous modifications and adaptations will be readily apparent to those of skill in the art without departing from the scope of the invention. Accordingly, this disclosure is not intended to embrace all such alternatives, modifications and variations that fall within the scope of the examples below and in view of the claims.

All publications, patents and patent applications mentioned in this specification are incorporated herein in their entirety by reference, to the same extent as if each individual publication, patent, or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

It is also to be understood that the article “a” or “an” refers to “at least one,” unless the context of a particular use requires otherwise.

The examples below further describe the foregoing and other non-limiting example embodiments in additional detail. Some embodiments below measure a policy impact by differences in post-disaster construction cost variations with a policy and without a policy, for example defined using a difference-in-differences (DiD) estimator as described herein.

A DiD estimator should be defined for measuring the impact of a policy on post-disaster construction cost variations. Specifically, a policy's impact on post-disaster construction cost variations may be modeled using the DiD estimator. To perform such computing of a disaster-related policy's impact on post-disaster construction cost variations, multiple factors are considered-including both the time trend in construction costs and the intervention effect of policy (e.g., a disaster-related policy).

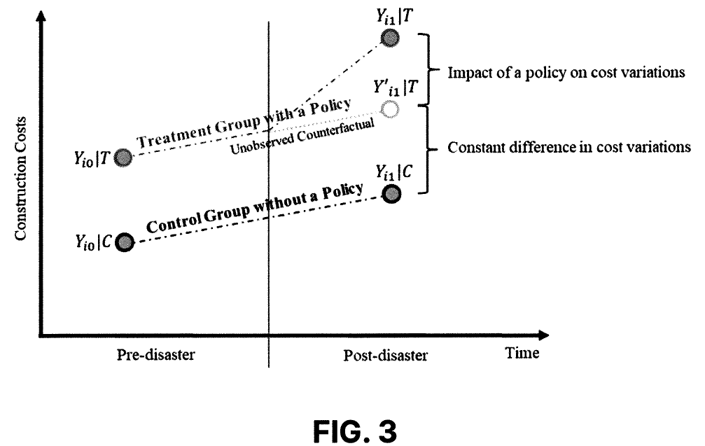

FIG. 3 depicts estimation of a policy impact on post-disaster construction cost variation. As illustrated, the pre-disaster construction costs in a treatment group affected by the policy may be represented by Yᵢ₀|T and the pre-disaster construction costs in a control group not affected by the policy is represented by Yᵢ₀|C. The post-disaster construction costs in a group affected by the disaster-related policy (“the policy”) is represented by Yᵢ₁|T and the post-disaster construction costs in a control group not affected by the policy is represented by Yᵢ₁|C. The nonparametric DiD estimator in some embodiments is represented by ((Yᵢ₁|T-Yᵢ₀|T)−(Yᵢ₁|C-Yᵢ₀ (C)). The parametric DiD estimator in some embodiments is represented as (E(Yᵢ₁|T)−E(Yᵢ₀|T))−(E(Yᵢ₁|C)−E(Yᵢ₀|C)).

Some embodiments then implement the DiD estimator and diagnose the estimation model. The DiD estimator in some embodiments is implemented as an interaction term in an estimation model as shown below:

$${Y}_{it} = {β}_{0} + {\sum }_{i = 1}^{I} {α}_{i} I ( i = ω ) + {\sum }_{t = 1}^{T} {β}_{t} I ( t = τ ) + γ {D}_{it} + δ {X}_{it} + {ε}_{it}$$

In this estimator, Ya is the construction costs in region I at time t, αᵢI(i=ω) represents a region affected by a disaster-related policy, βₜI(t=τ) represents a disaster occurrence, Dᵢₜ is a DiD estimator, Xᵢₜ is a vector of covariates to control for the effect of confounding variables on post-disaster construction cost variations, and εᵢₜ is an error term. The following table summarizes the coefficients of the DiD estimation model.

TABLE 1
Coefficients of an Example DiD Estimation Model

| Coefficient | Calculation | Interpretation |
|---|---|---|
| β₀ | Y_{I0}\|C | Baseline average |
| ${\sum }_{t = 1}^{T} {β}_{t}$ | ${Y}_{i 1} \vert C - {Y}_{i 0} \vert C$ | Time trend |
| ${\sum }_{i = 1}^{I} {α}_{i}$ | ${Y}_{i 0} \vert T - {Y}_{i 0} \vert C$ | The difference in pre- disaster cost variations with a policy and without a |
| | | policy |
| γ | (Yᵢ₁\|T − Yᵢ₀\|T) − (Yᵢ₁\|C − Yᵢ₀\|C) | A policy’s impact on post- |
| | | disaster cost variations |

After developing an estimation model with a DiD estimator, the model is diagnosed using two diagnostic tests: Breusch-Pagan and Hausman tests. These diagnostic tests are conducted to identify and select the appropriate computing model for the data. The Breusch-Pagan test is utilized to determine whether there are no time-invariant region-specific effects (αᵢ). The null hypothesis of the Breusch-Pagan test is that there are no time-invariant region-specific effects (αᵢ). If the null hypothesis is rejected, panel data models are more appropriate to capture the time-invariant region-specific effects (αᵢ).

The Hausman test is conducted to select between random-effects and fixed-effects models. The null hypothesis of the Hausman test is that there is no correlation between the independent variables (Xᵢₜ) and time-invariant region-specific effects (αᵢ). If the null hypothesis of the Hausman test is rejected, the fixed-effects model is selected as an appropriate panel data model and produces unbiased and consistent estimates, considering the correlation between the independent variables (Xᵢₜ) and time-invariant region-specific effects (αᵢ).

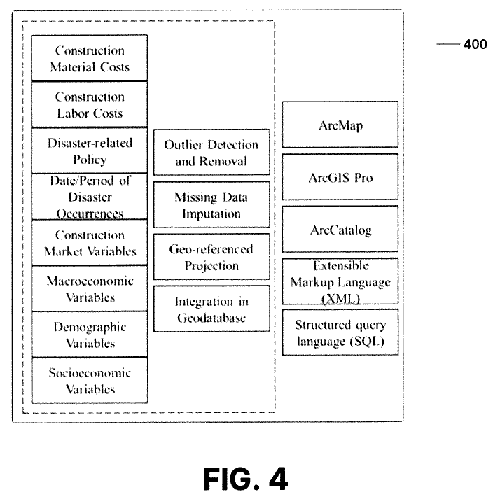

A geospatial-Geographic Information System (GIS) database may be developed accordingly. A geospatial GIS database in some embodiments is developed using the historical panel data entities including construction material costs, construction labor costs, disaster-related policy information, date or period of disaster occurrences, construction market variables (e.g., housing starts, construction spending), macroeconomic variables (e.g., GDP, inflation rates), demographic variables (e.g., ages, race, gender), and socioeconomic variables (e.g., poverty rates, income, education) on a plurality of regions. FIG. 4 depicts an example development of an example geospatial GIS database 400. As illustrated, the example geospatial GIS database 400 includes data of construction material costs, construction labor costs, disaster-related policy data, date/period of disaster occurrences data, construction market variables data, macroeconomic variables data, demographic variables data, and socioeconomic variables data. Such geospatial GIS database 400 data may be processed for outlier detection and removal, missing data imputation, geo-referenced projection, and/or integration into a geodatabase. The data of the geospatial GIS database 400 may be accessed and/or maintained via one or more applications, for example ArcMap, ArcGIS Pro, ArcCatalog, Extensible Markup Language (XML), and/or Structured Query Language (SQL), as described further herein.

In some embodiments, statistical models are used to detect and remove the outliers (e.g., that are higher than an upper threshold and less than a lower threshold) in the data entities. After detecting and removing the outliers, data imputation methods may be used in some embodiments, such as spatial multiple imputations that are used to handle missing data problems in the data entities.

In some embodiments, all data entities are projected in a geo-referenced coordination system to ensure proper attribution of all data entities in spaces. After the geo-referenced projection, all data entities are integrated and organized within a geodatabase, for example using ESRI ArcGIS desktop such as ArcMap and ArcGIS Pro. Metadata for each entity is created in layers, for example using the ESRI ArcCatalog platform, based on the Content Standard for Digital Geospatial Metadata (CSDGM). The developed geospatial GIS database provides a descriptive analysis of the data collection.

The geospatial GIS database is developed in a particular file format, for example in File Geodatabase format with the aid of ESRI ArcGIS Pro. The geospatial GIS database can be accessed via one or more database management software applications. For example, in some embodiments, the geospatial GIS database can be accessed via a structured query language (SQL) and/or various ESRI ArcGIS desktop applications, such as ArcMap, ArcGIS Pro, and ArcCatalog. The metadata associated with each data entity contained in the GIS database is created and updated using the ESRI ArcCatalog software (or other software), which adheres to the CSDGM. Additionally, the metadata of the data entities can be exported as an Extensible Markup Language (XML) file outside the GIS database. In some embodiments, the GIS database is compatible with ESRI ArcGIS Desktop applications (such as ArcMap, ArcGIS Pro, and ArcCatalog).

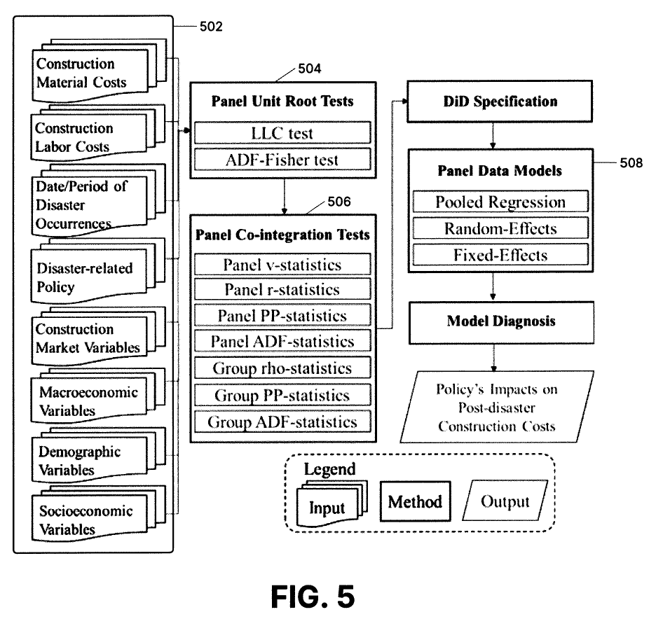

A system is then devised that computes the impact of a policy on post-disaster construction cost variations. An example system is depicted in FIG. 5. The computing system starts with selecting a policy to identify its impact on construction cost variation. A plurality of different data types is collected. Such data 502 includes construction material costs, construction labor costs, date or period of disaster occurrences, disaster-related policy information, and other confounding variables including construction market variables (e.g., housing starts, construction spending, and the like) macroeconomic variables (e.g., GDP, inflation rates, and the like), demographic variables (e.g., ages, race, gender, and the like), and socioeconomic variables (e.g., poverty rates, income, education, and the like). Panel unit root tests 504 are conducted to examine the stationarity of the panel data. Stationarity indicates a stochastic process, where the mean, variance, and autocorrelation parameters do not change over time. Panel data analysis using non-stationary panel data can cause spurious regression, misleading the estimation of a policy's impact on post-disaster cost variations. Panel unit root tests such as the Levin-Lin-Chu (LLC) test and the ADF-Fisher test can be conducted to assess the stationarity of variables.

Panel co-integration tests 506 are utilized to examine if a long-run relationship exists between the variables. The panel co-integration tests can be conducted using residual-based test statistics such as panel v-statistic, panel r-statistic, panel PP-statistic, panel ADF-statistic pool, Group rho-statistic, Group PP-statistic, and Group ADF-statistic. A natural logarithm transformation can be implemented for the data to avoid heteroskedasticity and non-stationarity phenomena before specifying a DiD estimator. The DiD estimator is defined and specified to model the impact of a policy on post-disaster construction cost variations. The DiD estimator is implemented into the panel data computing model for quantifying the impact of a policy on post-disaster construction cost variations.

Panel data models for estimating the policy's impact on post-disaster construction cost variations include pooled regression model, random-effects model, and fixed-effects model. The pooled regression model assumes no time-invariant region-specific effects (αᵢ), having constant coefficients. All the data may be pooled and estimated using the pooled ordinary least squares (OLS) methodology. Random effects model assumes that the time-invariant region-specific effects (αᵢ) are randomly distributed across the panel data (Xᵢₜ). The fixed-effects model can capture and estimate the time-invariant region-specific effects (αᵢ) across the panel data (Xᵢₜ).

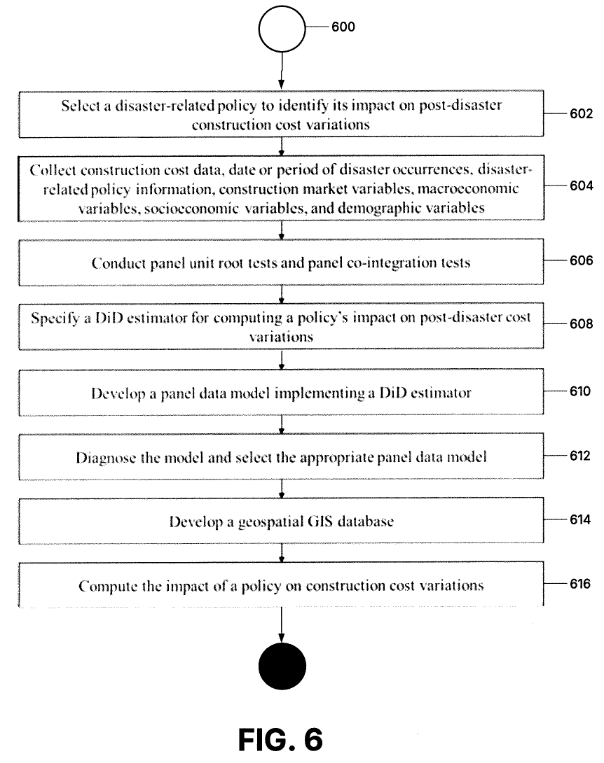

In some embodiments, the most appropriate panel data model among the candidate three models 508 (e.g., pooled regression, random-effects, and fixed-effects) is selected based on model diagnostic tests, such as the Breusch-Pagan and Hausman tests. The impact of a policy on post-disaster construction cost variations is computed based on the parameter of the DiD estimator (Y) in the appropriate panel data model. An example process for computing the policy's impact on post-disaster construction cost variations is summarized in the steps of FIG. 6.

As illustrated in FIG. 6, the steps include operation 602 to select a disaster-related policy to identify its impact on post-disaster construction cost variations. The steps further include operation 604 to collecting construction cost data, date or period of disaster occurrences, disaster-related policy information, construction market variables, macroeconomic variables, socioeconomic variables, and demographic variables. The steps further include operation 606 to conduct panel unit root tests and panel co-integration tests. The steps further include operation 608 to specify a DiD estimator for computing a policy's impact on post0disaster cost variations. The steps further include operation 610 to develop a panel data model implementing a DiD estimator. The steps further include operation 612 to diagnose the model and select the appropriate panel data model. The steps further include step 614 to develop a geospatial GIS database. The steps further include step 616 to compute the impact of a policy on construction cost variations. In some embodiments, the impact is computed utilizing the selected model, and/or the data of the GIS database. In some embodiments, the steps then end.

Often, construction costs increase after a disaster. Such sudden price inflation in the wake of a disaster is often denounced as price gouging. Price gouging occurs when a seller sharply increases the prices of necessary goods, services, and/or commodities beyond the reasonable level that covers increased costs.

In various jurisdictions, anti-price gouging regulations (e.g., laws) may be enacted to stabilize post-disaster price spikes and protect those affected from significantly increased costs. In some contexts, such anti-rice gouging laws only become in effect during a disaster or emergency upon the disaster declaration by an authority (e.g., a state governor, authorized local official, president of the United States, and/or the like). Various jurisdictions have laws or regulations against price gouging during a disaster or emergency, however some jurisdictions do not have any such anti-price gouging laws.

The effects of anti-price gouging laws have been debated. Often, the general public condemns price gouging, stating that it is unfair, immoral, exploitative, and impermissible. Price gouging undermines the equitability of access to the goods and services essential to minimal human functioning, for example hitting the poorest of a community the hardest. Substantial increases in construction costs in the wake of disasters can reduce the reconstruction speed in such communities. Unexpected construction labor cost inflation was found to be negatively correlated with the changes in the number of building permits in economically marginalized communities after disasters as well.

Reconstruction cost increases are often identified as a significant cause of project delay. Cumulative price increases are more than 20% over the insurance policy limit following catastrophes delayed post-disaster repairs since the policyholders needed to afford the extra repair costs by themselves. Many have called for price-gouging protections accordingly, however others such as economists consider that price hikes following unexpected disasters are a natural and appropriate market response to the shortage of essential goods and services that are in demand. These same parties suggest that the price controls can hinder post-disaster recovery by thwarting the work of the free market and discouraging favorable supply responses to increased demand.

Building permit data is frequently utilized to estimate the speed of post-disaster reconstruction as local statistics on new privately-owned residential construction. Data collection was performed for the number of total housing units newly constructed and authorized by monthly building permits 1 year before and after Hurricane Sandy struck two example jurisdictions-Virginia (which had price-gouging regulation at the time) and Maryland (which did not have price-gouging regulation at the time). The determinants of building permits were included in the analysis to control for confounding effects, including population, housing units, median household income, and the percentages of White, Black, and Hispanic populations were considered to monitor changes in monthly building permits. Poverty rates were also discussed as a predictor of monthly building permit issuances.

Seventy-six counties in Virginia and fourteen counties in Maryland were selected as disaster-affected counties since those whose monthly building permit data are available received federal assistance from FEMA in the aftermath of Hurricane Sandy. While the sample size of counties differs due to data unavailability and the different number of counties in each state, the panel dataset consists of more than 1,000 observations with more than 100 observations for each state, thus satisfying the central limit theorem. The panel data set is also strongly balanced, indicating that the variables used in the models are available for all counties and years in the sample. Controlling for county heterogeneity and common factors allows for the panel data models used in this research to yield consistent and unbiased estimates of the impact of anti-price gouging laws on the number of monthly building permits. The monthly building permits data in those counties were collected from November 2011 (1 year before Hurricane Sandy) to October 2013 (1 year after Hurricane Sandy). See the below table for the sample design and descriptive statistics.

TABLE 2
Building Permits Sample Design and Descriptive Statistics

| | All | VA | MD |
|---|---|---|---|
| Description | | | |
| Number of counties in the sample data | 90 | 76 | 14 |
| Number of pre-disaster sample data for | 1,080 | 912 | 168 |
| 12 months | | | |
| Number of post-disaster sample data for | 1,080 | 912 | 168 |
| 12 months | | | |
| Mean (units): | | | |
| Pre-disaster monthly building permit | 32.9 | 25.38 | 73.70 |
| counts | | | |
| Post-disaster monthly building permit | 41.04 | 30.69 | 97.26 |
| counts | | | |

The DiD estimator approach allows us to examine the effect of the intervention on an outcome by comparing the before and after average differences between a treatment group (e.g., that receives an intervention) and a control group (e.g., that does not receive the intervention). In other words, the DiD approach quantifies the effects of the treatment on the treated group (e.g., the extra average change in the outcome variable due to the treatment or intervention). This DiD approach enables a one-step analysis that controls for any other factors that can potentially affect the outcome for both the treatment and control group, assuming that the control and treatment groups are subject to the same trend. By estimating the pre- and post-difference between the treatment group and the control group in the outcome variable using DiD and eliminating other factors that can affect the outcome for both groups, the DiD estimator approach allows for quantifying the unbiased and consistent effect of a treatment on the treated group or the additional average change in outcome for the treated group due to the treatment.

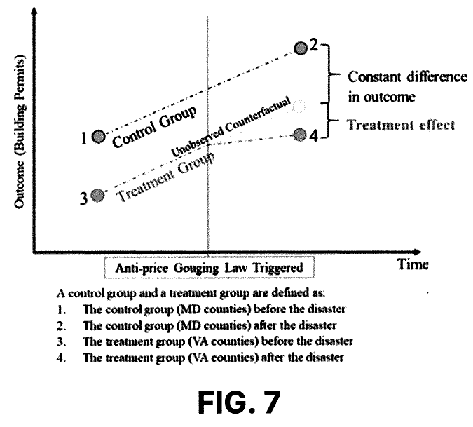

FIG. 7 represents the DiD framework utilized to estimate the effect of the anti-price gouging laws on the number of monthly building permits. The DiD approach quantifies the effects of the anti-price gouging law by comparing the pre-period and post-period changes in the average outcome of the treatment and control groups. One hypothesis to test is that the speed of monthly building permit issuances in the disaster-affected counties under the control of the anti-price gouging law would fall relative to the rate in post-disaster counties that are not under price-gouging control laws and/or regulations. In this regard, the treatment group is the disaster-affected counties in Virginia that have anti-price gouging law enforcement, and the control group is the disaster-affected counties in Maryland without the anti-price gouging las. The treatment effect may be estimated by the difference between the observed number of monthly building permits and the unobservable counterfactual trend in the treatment group (e.g., that indicates the number of monthly building permits in the treatment group without the anti-price gouging law).

DiD methods can be implemented using two different approaches, non-parametric and parametric approaches. The non-parametric approaches estimate the treatment effect as the difference in the changes in the outcome (e.g., monthly building permits) from the pre-disaster level to the post-disaster level between the control and treatment groups. The non-parametric approach may be expressed as:

$$τ = ( {BP}_{AT} - {BP}_{AC} ) - ( {BP}_{BT} - {BP}_{BC} )$$

In this formula, t is the treatment effect; BP_{AT} is the observed monthly building permits in the treatment group (e.g., disaster-affected counties in Virginia) after the disaster; BPAC is the observed monthly building permits in the control group (e.g., disaster-affected counties in Maryland) after the disaster; BP_{BT} is the observed monthly building permits in the treatment group before the disaster; and BP_{BC} is the observed monthly building permits in the control group before the disaster.

Alternatively or additionally, in some embodiments, a parametric approach may be used. The parametric approach assumes a regression model with a response variable (e.g., monthly building permits) and explanatory variables (e.g., including dummy variables) that indicate the treatment status. For example, the following formula in some embodiments represents the panel regression model with a DiD specification to examine the effect of the anti-price gouging law on the number of monthly building permits accounting for the unobserved time-invariant county-specific effects (αᵢ). The control variables were selected based on variance inflation factor (VIF) measurements were made to avoid the multicollinearity problem, and such selected variables included population, poverty rates, the percentage of the Black population, and the percentage of the Hispanic population. The formula is as follows:

$${BP}_{it} = {δ}_{0} + {β}_{1} {APG}_{i} + {β}_{2} {DIS}_{it} + {β}_{3} {APG}_{i} {DIS}_{it} + {β}_{4} {log ( POP )}_{it} + {β}_{5} {POV}_{it} + {β}_{6} {BLK}_{it} + {β}_{7} {HISP}_{it} + {α}_{1} + {ε}_{it}$$

In this formula, BPᵢₜ is the number of monthly building permits in a county I at a time t; APGᵢ is a dummy variable set to 1 if a county/is located in Virginia with the anti-price gouging law and 0 if a county/is located in Maryland without the anti-price gouging law; DISᵢₜ is a dummy variable set to 1 if time t is post-disaster for a county/and is set to 0 if time t is pre-disaster for a county i; APGᵢDISᵢₜ represents the interaction term defined as APGᵢ times DISᵢₜ and is a dummy variable set to 1 if a county/is in Virginia state and time t is post-disaster, and 0 otherwise; log (POP) it is the logarithmic form of the population in county I at the time t; POVᵢₜ is the poverty rates in county/at time t; BLKᵢₜ is a percentage of the Black population in county i at time t; HISPᵢₜ is the percentage of the Hispanic population in county i at time t; εᵢₜ is an error term; α₁ is individual effects to account for time-invariant county-specific heterogeneity, and β terms are coefficients to be estimated by the model.

A significant coefficient of APGᵢDISᵢₜ (β₃) or known as DiD, indicates that the effect of a disaster on the number of monthly building permits is moderated by whether a county I is located in Virginia with the anti-price gouging law or in Maryland without the anti-price gouging law. The formula may be examined using pooled ordinary least squares (OLS), fixed effects, or random-effects estimators. The pooled OLS estimator does not control for the unobserved time-invariant county-specific effects or unobservable county-specific heterogeneity (αᵢ) in the error term that may be correlated with variables of interest (such as geographical features, institutional quality, and the ability of the local administrators). Not accounting for such heterogeneity will lead to biased and inconsistent estimates. Therefore panel data models, including fixed-effects and random-effects models, may be employed as a parametric DiD approach to examine the effect of the anti-price gouging law on post-disaster reconstruction speed. In some embodiments, the data may be pre-processed to make balanced panel data before establishing the fixed-effects model and the random-effects model. Additionally or alternatively, in some embodiments, the fixed-effects and the random effects models have different assumptions on the county-specific effects (αᵢ), which are expressed in the formula below:

$${α}_{i} = {w}_{i} δ + {z}_{i} λ$$

In this formula, wᵢ represents all the unobserved county-specific effects correlated with explanatory variables; zᵢ represents all unobserved county-specific effects uncorrelated with explanatory variables; and δ and λ are unknown parameters. The random-effects model controls for the unobserved county-specific effects but assumes that they are not correlated with the independent variables in the model (e.g., that cov(αᵢ, Xᵢₜ)=0). On the other hand, the fixed-effects model allows the unobserved county-specific effects to be correlated with independent variables, and thus controls for the potential endogeneity of the independent variables due to these time-invariant county-specific factors.

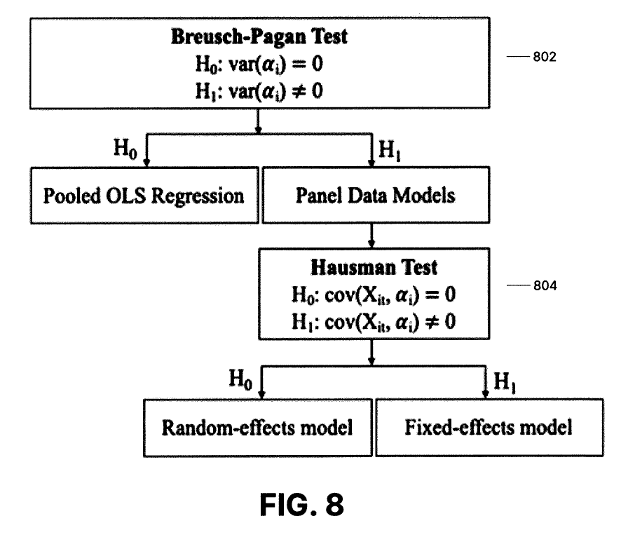

FIG. 8 illustrates a framework of a DiD parametric model selection process. In some embodiments, two specification tests are performed (e.g., Breusch-Pagan and Hausman tests) to identify the appropriate method to utilize. These tests assess whether the unobserved time-invariant county-specific effects (αᵢ) exist and are correlated with the independent variables. In order to determine whether the unobserved time-invariant county-specific effects (αᵢ) exist, a Lagrange multiplier test proposed by Breusch and Pagan (e.g., Breusch-Pagan test 802) may be used. The null hypothesis in this test is that there are no unobserved time-invariant county-specific effects (e.g., var (αᵢ)=0). A failure to reject the null hypothesis supports use of the OLS regression. If the null hypothesis is not rejected, the Hausman test 804 is performed to select between fixed-effects and random-effects models. The null hypothesis in this Hausman test is that the independent variables and the unobserved time-invariant county-specific effects (αᵢ) are not correlated. The fixed-effects model would be selected and used instead if the null hypothesis is rejected. When the unobserved time-invariant county-specific effects (αᵢ) are correlated with the independent variables, the fixed-effects model is preferred as it will yield unbiased and consistent estimates. On the other hand, the random-effects model is selected and used if the null hypothesis fails to be rejected, as the random effects will produce both consistent and efficient estimates. Regardless, the random-effects estimator allows for controlling for the within-county correlation in the error term, and thus yields more efficient estimates, and also yields consistent estimates if the independent variables are not correlated with the unobserved heterogeneity. The results from the random-effects estimator suffer from omitted variable bias if the independent variables are correlated with the time-invariant unobservable factors.

The non-parametric DiD analysis results on the anti-price gouging law effect on post-disaster monthly building permit issuances (which can represent reconstruction speed) is depicted in the table below.

TABLE 3
Non-Parametric DiD Analysis Results

| Monthly | | | | | |
|---|---|---|---|---|---|
| Building | | Before | After | | DiD With |
| Permits | All | Sandy | Sandy | DiD | Controls |
| VA | 28.04 | 25.38 | 30.68 | 5.3 | 5.25^{a} |
| (Treatment) | | | | (3.01) | (1.89) |
| MD | 85.48 | 73.69 | 97.26 | 25.56^{b} | 21.9^{b} |
| (Control) | | | | (11.01) | (8.65) |
| Change in | −57.44 | −48.31 | −66.58 | −18.26^{b} | −17.88^{b} |
| Monthly BP | | | | (8.47) | (8.94) |
| (τ) | | | | | |

Note that the standard errors are given in parentheses.
^{a}Rejection of the null hypothesis at 1% significance level.
^{b}Rejection of the null hypothesis at the 5% significance level.

The results of the non-parametric DiD analysis shows that the anti-price gouging law decreased the building permit issuances by 17.88 units monthly during the post-disaster situation. The anti-price gouging law thus can negatively affect the speed of post-disaster recovery in Virginia relative to Maryland.

The parametric DiD analysis results on the anti-price gouging law effect on post-disaster monthly building permit issuances is depicted in the table below.

TABLE 4
Parametric DiD Analyses Results

| | |
|---|---|
| Data | Monthly Building Permits (Units) |

| Variables | Fixed Effects (FE) | Random Effects (RE) |
|---|---|---|
| APGᵢ | — | 2.505 |
| | | (13.45) |
| DISᵢₜ | 15.36^{a} | 15.65^{a} |
| | (6.416) | (6.384) |
| APGᵢDISᵢₜ | −18.04^{b} | −18.05^{b} |
| | (5.76) | (5.73) |
| log(POP)ᵢₜ | 442.8^{a} | 28.60^{b} |
| | (172.7) | (3.945) |
| POVᵢₜ | 0.777 | −0.924 |
| | (1.334) | (0.739) |
| BLKᵢₜ | 622.0 | 3.619 |
| | (770.8) | (29.36) |
| HISPᵢₜ | −327.7 | 123.2 |
| | (973.0) | (73.69) |
| Intercept | — | −283.5^{b} |
| | | (48.9) |
| Time dummy | Yes | Yes |
| Observations | 2,160 | 2,160 |

Note:
Robust standard errors are given in parentheses.
^{a}Rejection of the null hypothesis at the 5% significance level.
^{b}Rejection of the null hypothesis at the 1% significance level.

The parametric DiD analysis shows a statistically significant positive effect on the number of monthly building permits regardless of the existence of the anti-price gouging law. The disaster occurrence increases the number of monthly building permits by approximately 15 units.

The following tables indicates the results of the relevant tests for model selection.

TABLE 5
Breusch-Pagan Test Results

| | Chi-Square | | |
|---|---|---|---|
| Monthly Building Permits | Statistic | Degree of Freedom | p-value |
| Lagrange Multiplier Test | 3,346.1 | 1 | 0.00 |
| for Balanced Panels | | | |

TABLE 6
Hausman Test Results:

| Hausman Test | Chi-square Statistic | p-value |
|---|---|---|
| Fixed Effects Versus Random Effects | 9.969 | 0.126 |

The null hypothesis of no individual effects was rejected according to the results of the Breusch-Pagan tests. In other words, statistically significant individual heterogeneity exists among the county-level building permit data. The null hypothesis was rejected at the 1% significance level, indicating no individual fixed effects. Based on this result, the fixed-effects model is selected as more appropriate to control for the county-specific effects than the pooled OLS regression model. The Breusch-Pagan test to choose between the pooled OLS regression and the random-effects models similarly indicates that the OLS pooled regression model is not appropriate. Specifically, the null hypothesis of no individual random effects was rejected at a 1% significance level again, therefore the random-effects model is more appropriate to control for the county-specific effects than the pooled OLS regression model.

The Hausman test failed to reject the null hypothesis that the independent variables and fixed effects (αᵢ) are not correlated. Given the test results, the null hypothesis of the Hausman test failed to be rejected at the 5% significance level, indicating that the random-effects model is more appropriate than the fixed-effects model. In some embodiments, the random-effects model is selected for use, for example as an estimator as described herein. In this regard, the random-effects model may provide the most accurate results for DiD analysis. In other implementations, such as when the null hypothesis of the Hausman test is rejected, the fixed-effects model may be selected for use instead.

### II. Systems and Methods

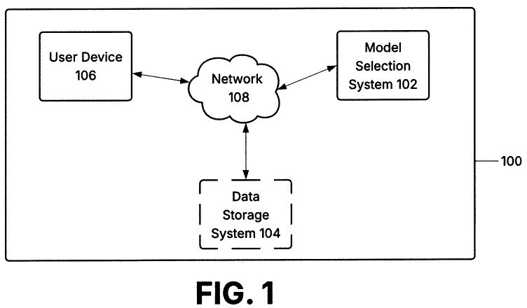

FIG. 1 depicts an example system in accordance with at least some example embodiments of the present disclosure. Specifically, FIG. 1 depicts an example model selection system 100 (“system 100”). The system 100 is configured to select a model and/or use the selected model. In this regard, the system 100 may be specially configured to select a model for accurately determining the impact of a disaster-related policy on post-disaster construction cost.

The system 100 includes a model selection system 102, an optional data storage system 104, and a user device 106. In some embodiments, the model selection system 102 is specially configured in accordance with the example use case depicted and described above. The model selection system 102, user device 106, and/or optional data storage system 104 in some embodiments communicate via the network 108.

The system 100 in some embodiments includes the model selection system 102. In some embodiments, the model selection system 102 embodies or includes a server, database, computing system, and/or the like. In some embodiments, the model selection system 102 is specially configured to select a model for use from a plurality of models. Additionally or alternatively, in some embodiments, the model selection system 102 is specially configured to utilize a selected model, for example to compute an impact of a selected disaster-related policy. In some embodiments, the model selection system 102 is specially configured in accordance with the example use case described above.

The system 100 in some embodiments optionally includes at least one data storage system 104. In some embodiments, a data storage system 104 embodies or includes a server, database, computing system, and/or the like. In some embodiments, the data storage system 104 is configured to collect, store, maintain, and/or provide access to data utilized by the model selection system 102 for model selection and/or use. For example, in some embodiments, the data storage system 104 stores historical data associated with a disaster-related policy, including data associated with a geographic area, population in a geographic area, construction-related costs, and/or the like. Additionally or alternatively, in some embodiments the data storage system 104 includes confounding data stored associated with a particular disaster-related policy, geographic area associated therewith, and/or the like. It should be appreciated that multiple different data storage systems may be maintained in some embodiments, for example where data from multiple independent sources, providers, and/or the like are utilized to perform model selection and/or use. In some embodiments, the data storage system 104 is embodied by or as a sub-system of the model selection system 102, for example where the model selection system 102 pre-collects, stores, maintains, and/or otherwise compiles disaster-policy-related data for subsequent use without having to access any external system.

The system 100 in some embodiments includes the user device 106. In some embodiments, the user device embodies or includes a user smartphone, tablet, computer, laptop, end terminal, and/or the like. In some embodiments, the user device 106 is specially configured to execute computer-coded instructions (e.g., one or more software applications, including one or more native applications and/or web applications) that enables access to functionality of the model selection system 102. In some embodiments, the user device 106 is embodied as a sub-system of the model selection system 102, for example embodied as at least one user input/output device, terminal, circuitry, and/or the like. In some embodiments, the user device 106 is configured to enable access to functionality of the model selections system 102. For example, in some embodiments, the user device 106 receives user input that performs selection of a particular model, and/or that utilizes the selected model for a particular computation.

In some embodiments, the network 108 communicatively couples the model selection system 102, user device 106, and/or optional data storage system 104. In some embodiments, the network 108 provides such communication capabilities either via direct connection between the various devices and/or sub-systems, an indirect connection between the devices and/or sub-systems, and/or any combination thereof. For example, in some embodiments, the network 108 is embodied by the Internet, where access to the Internet is facilitated via one or more specially configured modems, routers, switches, and/or the like. Additionally or alternatively, in some embodiments, the network 108 is embodied by specialized protocol communications between the devices and/or sub-systems. Any of a myriad of known communications protocols and/or methodologies may be implemented, for example Bluetooth 3, Bluetooth Low Energy, Wi-Fi, cellular data communication (e.g., whether 3G, LTE, 5G, and/or the like), other radio frequency protocols, and/or the like.

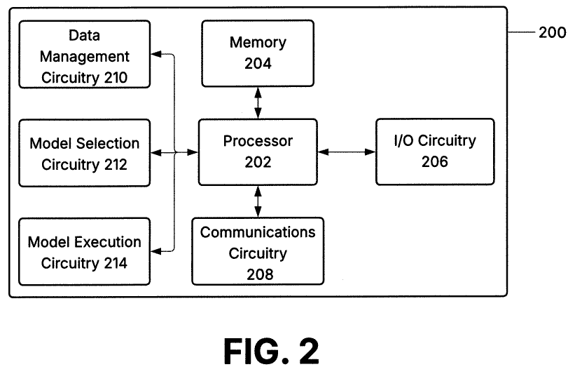

FIG. 2 is system architecture diagram of a model selection and use apparatus 200 (“apparatus 200”) in accordance with an exemplary embodiment of the present disclosure. In some embodiments, the apparatus 200 embodies the model selection system 102 as depicted and described with respect to FIG. 1 herein. In this regard, the apparatus 200 in some embodiments is specially configured to perform one or more methods for model selection and/or model use, as described herein. For example, in some embodiments, the apparatus 200 is specially configured to perform the operations associated with the example use case described above.

As illustrated in FIG. 2, the apparatus 200 includes a processor 202, a memory 204, input/output (“I/O”) circuitry 206, communications circuitry 208, data management circuitry 210, model selection circuitry 212, and model execution circuitry 214. The apparatus 200 may be configured to execute some or all of the operations described herein with respect to model selection and/or model use. Although the circuitry 202-214 are described with respect to functional limitations, it should be understood that the particular implementations necessarily include the use of particular hardware. It should also be understood that certain of these components 202-214 may include similar or common hardware. For example, two modules may both leverage use of the same processor, network interface, storage medium, or the like, to perform their associated functions, such that the duplicate hardware is not required for each individually named circuitry.

The use of the term “circuitry” as used herein with respect to the components of the apparatus will be understood to include particular hardware configured to perform the functions associated with the particular module circuitry depicted and described. The term “circuitry” should be understood broadly to include hardware, software that configures the hardware, firmware that configures the hardware, and/or any combination thereof. For example, in some embodiments, “circuitry” may include processing circuitry, storage media, network interfaces, input and/or output devices, and the like. In some embodiments, other elements of the apparatus 200 may provide or supplement the functionality of particular circuitry. For example, in some embodiments, the processor 202 provides processing functionality, the memory 204 provides storage functionality, the communications circuitry 208 provides network interface functionality, and the like.

It should be appreciated that, in some embodiments, some or all of the circuitry may be associated with a separate device, server, and/or associated computing hardware, which may be in communication with one or more of the other circuitry components of the apparatus 200. For example, in some embodiments, the data management circuitry 210, model selection circuitry 212, and/or model execution circuitry 214 is included in and/or embodied by a separate computing apparatus. The separate computing apparatus in some embodiments may include a separate processor, memory, I/O circuitry, and/or communications circuitry.

In some embodiments, the processor 202 (and/or co-processors in some embodiments is in communication with the memory 204 via a bus for passing information among components of the apparatus 200. The memory 204 may be non-transitory and in some embodiments includes one or more volatile and/or non-volatile memories. In other words, for example, the memory 204 in some embodiments is an electronic storage device (e.g., a computer-readable storage medium). The memory 204 in some embodiments is configured to store and/or provide access to data maintained by the apparatus 200, for example to enable the apparatus 200 to carry out various functions utilizing such data as described herein.

The processor 202 may be embodied in any of a myriad of different ways. For example, in some embodiments, the processor 202 includes one or more processing devices and/or sub-processors configured to perform independently. Additionally or alternatively, in some embodiments the processor 202 may include one or more processors configured to operate in tandem via a bus, for example to enable independent execution of instructions, pipelining, and/or multithreading. The use of the terms “processing device,” “processor,” and/or “processing circuitry” may be understood to include a single core processor, a multi-core processor, multiple processors internal to the apparatus 200, and/or one or more separate, remote, and/or “cloud” processors.

In some embodiments, the processor 202 is configured to execute computer-coded instructions stored in the memory 204, or otherwise accessible to the processor 202. Alternatively or additionally, the processor 202 in some embodiments is configured to execute hard-coded functionality. As such, whether configured by hardware or software, or by a combination of hardware with software, the processor 202 in some embodiments represents an entity (e.g., physically embodied in the circuitry) capable of performing operations in accordance with one or more embodiments of the present disclosure when configured accordingly. Alternatively, as another example, when the processor is embodied as an executor of software instructions, the computer-coded instructions in some embodiments specifically configure the processor to perform steps described here, for example embodying one or more algorithms and/or operations thereof.

In some embodiments, the apparatus 200 includes I/O circuitry 206 that may, in turn, be in communication with the processor 202 to provide output to the user associated with the apparatus 200. Additionally or alternatively, in some embodiments, the I/O circuitry 206 is in communication with the processor 202 to receive input from a user. The I/O circuitry 206 in some embodiments comprises a user interface, for example a device display, web interface, mobile application, client device, and/or the like. Additionally or alternatively, in some embodiments, the I/O circuitry 206 includes one or more input devices, for example a keyboard, a mouse, a joystick, a touch screen, a microphone, and/or input/output mechanisms. The I/O circuitry 206, alone or together with the processor 202, in some embodiments controls one or more functions of the user interface, for example through executing computer-coded instructions stored on the memory 204 or otherwise accessible to the processor 202 (e.g., embodied in software and/or firmware). The communications circuitry 208 in embodied in hardware, or a combination of both hardware and software, that is configured for data receiving and/or data transmission, for example over a network. The communications circuitry 208 may transmit data from the apparatus 200, and/or receive data at the apparatus 200 from another device, system, and/or the like. In some embodiments, the communications circuitry 208 includes at least one network card, at least one antenna, at least one switch, at least one router, at least one modem, at least one bus connecting components, and/or supporting hardware and/or software of any such components. In some embodiments, the communications circuitry 208 is a separate device that is configured to enable the apparatus 200 to perform such data receiving and data transmitting. For example, in some embodiments, the communications circuitry 208 is configured to interact with at least one antenna to facilitate signal transmission, and/or facilitate signal reception via the at least one antenna. In some embodiments, the apparatus 200 is configured to communicate via the communications circuitry 208 utilizing any communications protocol, or a combination of multiple communications protocol. Non-limiting examples of such communications protocols include Bluetooth Low Energy, infrared wireless communication, ultra-wideband communication, Wi-Fi, Near Field Communication, Worldwide Interoperability for Microwave Access, and/or the like.

In some embodiments, the data management circuitry 210 includes hardware, software, and/or any combination thereof, that is specially configured to provide data receiving, retrieval, storage, maintenance, and/or access capabilities. In some embodiments, the data management circuitry 210 is specially configured to collect data associated with a disaster-related policy. Non-limiting examples of such data includes, in some embodiments, one or more of construction material costs, construction labor costs, construction equipment costs, date or period of disaster occurrences, disaster-related policy information, confounding variable data including one or more construction market variable data, macroeconomic variable data, demographic variable data, socioeconomic data, and/or the like. Additionally or alternatively, in some embodiments, the data management circuitry 210 is specially configured to develop a geospatial GIS database comprising collected data. In some embodiments, the data management circuitry 210 is configured to store and/or maintain previously-collected data associated with the disaster-related policy. Additionally or alternatively, in some embodiments, the data management circuitry 210 is configured to provide access to one or more data storage system (including and without limitation at least one external data storage system) that further includes data associated with a disaster-related policy for use.

In some embodiments, the model selection circuitry 212 includes hardware, software, and/or any combination thereof, that is specially configured to select a model for use. In some embodiments, the model selection circuitry 212 is specially configured to specify an estimator. Additionally or alternatively, in some embodiments, the model selection circuitry 212 is specially configured to select a panel data model of a plurality of models to implement an estimator, for example using collected data. In some embodiments, the model selection circuitry 212 maintains a determination of a selected model (e.g., a panel data model) for subsequent use. In some embodiments, the model selection circuitry 212 is configured to perform one or more diagnostic tests and utilize the results of the one or more diagnostic test to select a model. Additionally or alternatively, in some embodiments, the model selection circuitry 212 is configured to conduct one or more panel unit root test and/or one or more panel co-integration test, and the model selection circuitry 212 is configured to select a model based on the results of the one or more panel unit root test and/or one or more panel co-integration test.

In some embodiments, the model execution circuitry 214 includes hardware, software, and/or any combination thereof, that is specially configured to use a selected model for one or more computer-implemented processes. In some embodiments, the model execution circuitry 214 is specially configured to compute an impact of a selected disaster-related policy, for example using a selected panel data model and a GIS database. In some embodiments, the model execution circuitry 214 provides access to a previously-selected model for use in one or more processes, for example to compute an impact of a selected disaster-related policy. In some embodiments, the model execution circuitry 214 is specially configured to enable selection of a disaster-related policy for analysis, for example using a selected (or to-be-selected) model.

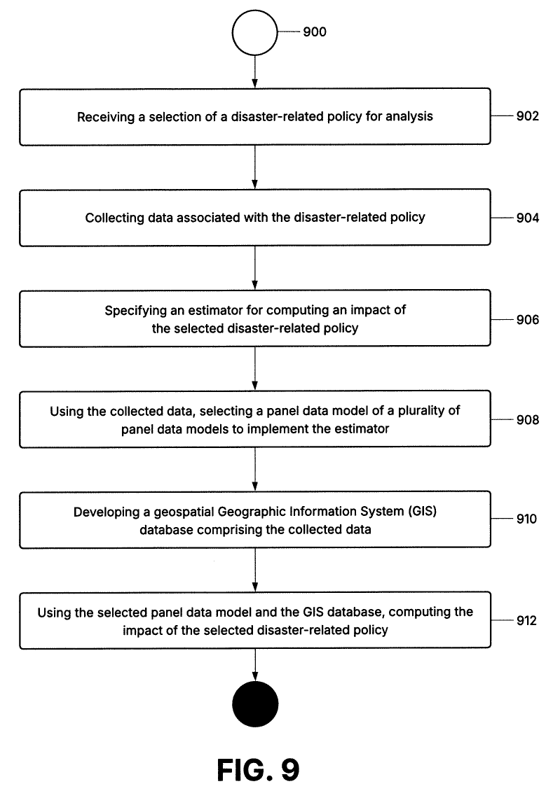

FIG. 9 depicts an example method. Specifically, FIG. 9 depicts an example method 900 for selecting a model for accurately determining the impact of a disaster-related policy. The method in some embodiments is performed using a specially configured apparatus, for example the apparatus 200 as depicted and described herein with respect to the figures above. Additionally or alternatively, in some embodiments, the method is performed in communication with one or more other sub-systems, for example a user device and/or data storage system as depicted and described herein.

In some embodiments, the example method includes one or more optional steps. An optional step may be depicted in dashed (or “broken”) lines. It should be appreciated that, in some embodiments, some or all of the optional steps of a method may be performed. Additionally or alternatively, in some embodiments, none of the optional steps of a method may be performed.

At operation 902, the method 900 includes receiving a selection of a disaster-related policy for analysis. In some embodiments, the disaster-related policy is selected in response to user input indicating the selected disaster-related policy. Additionally or alternatively, in some embodiments, the disaster-related policy is automatically selected, for example as part of analyzing a plurality of disaster-related policies, geographic areas, and/or the like.

At operation 904, the method 900 includes collecting data associated with the disaster-related policy. In some embodiments, the data is collected from any number of data storage systems, for example external data storage systems. Additionally or alternatively, in some embodiments, the data is collected from an aggregation database maintained by a model selection system, for example embodied by the apparatus 200. The data associated with a disaster-related policy may include data associated with a geographic area, population in a geographic area, construction-related costs, confounding data stored associated with a particular disaster-related policy, geographic area associated therewith, and/or the like. Non-limiting examples of such data include one or more of construction material costs, construction labor costs, construction equipment costs, date or period of disaster occurrences, disaster-related policy information, confounding variable data including one or more construction market variable data, macroeconomic variable data, demographic variable data, socioeconomic data, and/or the like.

At operation 906, the method 900 includes specifying an estimator for computing an impact of the selected disaster-related policy. In some embodiments, the method includes specifying an estimator between a parametric estimator and a non-parametric estimator. Additionally or alternatively, in some embodiments, the estimator that is selected is used to select a particular model to implement the estimator, as described herein.

At operation 908, the method 900 includes, using the collected data, selecting a panel data model of a plurality of panel data models to implement the estimator. The selected panel data model in some embodiments is “selected” for subsequent use in a computer-implemented process, for example to compute the impact of a disaster-related policy. In some embodiments, one or more diagnostic tests are conducted to select a panel data model of a plurality of panel data models to implement the estimator. For example, in some embodiments, the diagnostic tests include a Breusch-Pagan test and/or a Hausman test, as described herein. Additionally or alternatively, in some embodiments the selected panel data model is based on results of one or more panel unit root tests, such as a LLC test and/or ADF-Fisher test that assesses stationarity of variables as described herein. In some embodiments, the selected panel data model is selected from a set of various model types, for example a pooled regression model, a random-effects model, and/or a fixed-effects model.

At operation 910, the method 900 includes developing a geospatial Geographic Information System (GIS) database comprising the collected data. In some embodiments, the geospatial GIS database includes historical data values associated with a particular disaster-related policy, for example associated with the policy itself, an area associated with the disaster-related policy, historical action data, and/or the like. The geospatial GIS may include a portion of stored data, specifically that is associated with the disaster-related policy rather than all stored data (e.g., including other data not associated with the disaster-related policy).

At operation 912, the method 900 includes, using the selected panel data model and the GIS database, computing the impact of the selected disaster-related policy. In some embodiments, the data of the GIS database is applied to the selected panel data model to compute the impact of the selected disaster-related policy. In some embodiments, the impact is output from the selected panel data model, and may be further processed, displayed to a user, and/or otherwise output.

### III. Conclusion

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system comprising:
one or more processors; and
a non-transitory memory in communication with the one or more processors, and storing instructions thereon, that when executed by the one or more processors, are configured to cause the system to:
receive a selection of a disaster-related policy for analysis;
collect data associated with the disaster-related policy;
specify an estimator for computing an impact of the selected disaster-related policy;
using the collected data, select a panel data model of a plurality of panel data models to implement the estimator;
develop a geospatial Geographic Information System (GIS) database comprising the collected data; and
using the selected panel data model and the GIS database, compute the impact of the selected disaster-related policy.

2. The system of claim 1, wherein the data associated with the disaster-related policy comprises one or more of construction material costs, construction labor costs, construction equipment costs, date or period of disaster occurrences, disaster-related policy information, and one or more confounding variables.

3. The system of claim 2, wherein the one or more confounding variables comprise one or more of construction market variables, macroeconomic variables, demographic variables, and socioeconomic variables.

4. The system of claim 1, wherein the estimator comprises a difference-in-difference (DiD) estimator.

5. The system of claim 1, wherein to select the panel data model the system is caused to:
perform a first diagnostic test to determine whether one or more time-invariant region-specific effects are present; and
in response to the one or more time-invariant region-specific effects being present, perform a second diagnostic test to determine whether the one or more time-invariant region-specific effects are correlated with at least one independent variable of the selected panel data model.

6. The system of claim 5, wherein the first diagnostic test comprises a Breusch-Pagan test and the second diagnostic test comprises a Hausman test.

7. The system of claim 5, wherein:
the selected panel data model comprises a pooled regression model when the one or more time-invariant region-specific effects are not present;
the selected panel data model comprises a random-effects model when at least one of the one or more time-invariant region-specific effects are not correlated with at least one independent variable of the selected panel data model; and
the selected panel data model comprises a fixed-effects model when at least one of the one or more time-invariant region-specific effects are correlated with at least one independent variable of the selected panel data model.

8. The system of claim 1, wherein the non-transitory memory comprises additional instructions, that when executed by the one or more processors, are configured to cause the system to:
conduct one or more panel unit root tests to determine a stationarity of the collected data;
responsive to determining the collected data is non-stationary:
conduct one or more panel co-integration tests to determine whether a long-run relationship exists between variables of the collected data; and
implement a natural logarithm transformation on the collected data prior to specifying the estimator to correct for heteroskedasticity and non-stationarity.

9. A method comprising:
selecting a disaster-related policy for analysis;
collecting data associated with the disaster-related policy;
specifying an estimator for computing an impact of the selected disaster-related policy;
using the collected data, selecting a panel data model of a plurality of panel data models to implement the estimator;
develop a geospatial GIS database comprising the collected data; and
using the selected panel data model and the GIS database, compute the impact of the selected disaster-related policy.

10. The method of claim 9, wherein the data associated with the disaster-related policy comprises one or more of construction material costs, construction labor costs, construction equipment costs, date or period of disaster occurrences, disaster-related policy information, and one or more confounding variables.

11. The method of claim 10, wherein the one or more confounding variables comprise one or more of construction market variables, macroeconomic variables, demographic variables, and socioeconomic variables.

12. The method of claim 9, wherein the estimator comprises a difference-in-difference (DiD) estimator.

13. The method of claim 9, wherein selecting the panel data model comprises:
performing a first diagnostic test to determine whether one or more time-invariant region-specific effects are present; and
in response to the one or more time-invariant region-specific effects being present, performing a second diagnostic test to determine whether the one or more time-invariant region-specific effects are correlated with at least one independent variable of the selected panel data model.

14. The method of claim 13, wherein the first diagnostic test comprises a Breusch-Pagan test and the second diagnostic test comprises a Hausman test.

15. The method of claim 13, wherein:
the selected panel data model comprises a pooled regression model when the one or more time-invariant region-specific effects are not present;
the selected panel data model comprises a random-effects model when at least one of the one or more time-invariant region-specific effects are not correlated with at least one independent variable of the selected panel data model; and
the selected panel data model comprises a fixed-effects model when at least one of the one or more time-invariant region-specific effects are correlated with at least one independent variable of the selected panel data model.

16. The method of claim 9, further comprising:
conducting one or more panel unit root tests to determine a stationarity of the collected data;
responsive to determining the collected data is non-stationary:
conducting one or more panel co-integration tests to determine whether a long-run relationship exists between variables of the collected data; and
implementing a natural logarithm transformation on the collected data prior to specifying the estimator to correct for heteroskedasticity and non-stationarity of the collected data.

17. A non-transitory computer-readable storage medium having computer instructions stored thereon that, when executed by at least one processor, are configured for selecting a disaster-related policy for analysis;
collecting data associated with the disaster-related policy;
specifying an estimator for computing an impact of the selected disaster-related policy;
using the collected data, selecting a panel data model of a plurality of panel data models to implement the estimator;
develop a geospatial GIS database comprising the collected data; and
using the selected panel data model and the GIS database, compute the impact of the selected disaster-related policy.

18. The non-transitory computer-readable storage medium of claim 17, wherein the estimator comprises a difference-in-difference (DiD) estimator.

19. The non-transitory computer-readable storage medium of claim 17, wherein selecting the panel data model comprises:
performing a first diagnostic test to determine whether one or more time-invariant region-specific effects are present; and
in response to the one or more time-invariant region-specific effects being present, performing a second diagnostic test to determine whether the one or more time-invariant region-specific effects are correlated with at least one independent variable of the selected panel data model.

20. The non-transitory computer-readable storage medium of claim 19, wherein the first diagnostic test comprises a Breusch-Pagan test and the second diagnostic test comprises a Hausman test.
